(19) United States
(12) Patent Application Publication
(10) Pub. No.: US 2016/0323506 A1
(43) Pub. Date: Nov. 3, 2016

(54) CONTROL TECHNIQUES FOR UTILIZING MOBILE DEVICES IN ATYPICAL ENVIRONMENTS

(71) Applicant: LASO TECHNOLOGIES, LLC, Cheyenne, WY (US)

(72) Inventors: Andrew Laird, New York, NY (US); Mathew Andon, Boston, MA (US); John Eric Oberbeck, New York, NY (US); James Staley, Somerville, MA (US)

(21) Appl. No.: 15/139,589

(22) Filed: Apr. 27, 2016

Related U.S. Application Data
(60) Provisional application No. 62/153,002, filed on Apr. 27, 2015.

(51) Int. Cl. H04N 5/232

(52) U.S. Cl. CPC H04N 5/23245; H04N 5/23216; H04W 88/02

(57) ABSTRACT

Methods, articles and systems are provided to enable a human user to control particular functions of a processor-based mobile computing device by utilizing hardware actuators of the mobile computing device, such as when touchscreen or other capacitive controls of the computing device may be unreliable or unavailable based on an atypical physical environment or enclosure of the mobile computing device within an external device case. An executing mobile application may assign a first function of the mobile application and/or mobile computing device to a first hardware actuator of the mobile computing device, and assign a set of additional functions of the mobile application and/or mobile computing device to other hardware actuators.

### FIELD

This disclosure relates to the use of mobile devices in environments or situations in which access to particular controls may be unreliable or unavailable.

### BACKGROUND

A growing variety of mobile devices include the functionality of a camera. It would be desirable to use mobile devices for photography or videography in wet environments or underwater. However, many such mobile devices are not compatible with water, must be kept dry, or are unable to resist water below a certain depth. Furthermore, even for mobile devices that are otherwise tolerant of wet or underwater environments, the functionality of such devices may be severely compromised, as they typically depend on capacitive touchscreens or other similar controls that are largely inoperable due to aquatic interference with human input. In particular, water acts as an insulator and thereby prevents normal capacitive operations.

Therefore, there remains a need for products which allow the use of mobile devices in wet environments, underwater, or other scenarios in which access to particular controls may be unreliable or unavailable.

### SUMMARY

According to at least one embodiment, a method implemented by a processor-based computing device is provided. The method includes providing a user interface having a plurality of modes, such that each of the plurality of modes is associated with particular functions of the computing device. At least one of the device functions associated with a particular mode is unavailable for use during operation while the computing device is operating in at least one other of the modes. The providing of the user interface includes assigning a mode selection function to a first hardware actuator of the computing device; causing the computing device to operate in a first of the plurality of modes; and, in response to a first activation of the first hardware actuator, causing the computing device to operate in a distinct second of the plurality of modes. Causing the computing device to operate in the first mode includes assigning a first set of the one or more device functions associated with the first mode to one or more second hardware actuators of the computing device. Causing the computing device to operate in the distinct second mode includes assigning a distinct second set of the one or more device functions associated with the distinct second mode to the one or more second hardware actuators of the computing device.

According to certain embodiments, a non-transitory computer-readable storage medium has stored contents that, when executed, configure a computing device having a plurality of hardware actuators to perform automated operations. The automated operations include assigning a first function to a first of the hardware actuators; in response to a first user activation of the first hardware actuator, assigning a first set of additional device functions to one or more of the plurality of hardware actuators other than the first hardware actuator; and, in response to a distinct second user activation of the first hardware actuator that occurs after the first user activation of the first hardware actuator, assigning a distinct second set of additional device functions to the one or more other hardware actuators. In at least one such embodiment, the first function is a mode selection function, and the plurality of modes are logically arranged in a predefined order—such that the stored contents further configure the computing device to, in response to activation of the mode selection function, shift operation to a next mode in the predefined order.

According to another embodiment, a system comprises an external device case that includes one or more buttons (each configured to sealingly extend when actuated in order to activate a corresponding hardware actuator of a computing device when that computing device is enclosed by the external device case), and a non-transitory computer-readable medium having contents that, when executed by a computing device, cause the computing device to perform a method. The method includes providing a user interface having a plurality of modes, such that each of the plurality of modes is associated with particular functions of the computing device. At least one of the device functions associated with a particular mode is unavailable for use during operation while the computing device is operating in at least one other of the modes. The providing of the user interface includes assigning a mode selection function to a first hardware actuator of the computing device; causing the computing device to operate in a first of the plurality of modes; and, in response to a first activation of the first hardware actuator, causing the computing device to operate in a distinct second of the plurality of modes. Causing the computing device to operate in the first mode includes assigning a first set of the one or more device functions associated with the first mode to one or more second hardware actuators of the computing device. Causing the computing device to operate in the distinct second mode includes assigning a distinct second set of the one or more device functions associated with the distinct second mode to the one or more second hardware actuators of the computing device.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 depicts a block diagram of an exemplary computing system in accordance with an embodiment as disclosed herein.

FIG. 2 is a top perspective view of an embodiment of an exemplary device compatible with various techniques disclosed herein.

FIG. 3 is a top perspective view of an embodiment of a device case operable to enclose a device during operations disclosed herein.

FIG. 4 illustrates particular elements of a mobile application user interface provided in accordance with techniques and embodiments described herein.

FIG. 5 is a state diagram of an embodiment of device function assignment in accordance with techniques described herein.

### DETAILED DESCRIPTION

Techniques described herein generally enable a human user to control particular functions of a processor-based mobile computing device by utilizing hardware buttons or other actuators of the mobile computing device when touchscreen or other capacitive controls of the computing device may be unreliable or unavailable. As one non-exclusive example, a typical mobile computing device may include a capacitive touchscreen and various hardware actuator controls, with only the hardware actuator controls being available for use in wet or underwater environments. The described techniques include assigning particular functions to hardware actuator controls of the mobile computing device, enabling a user to access functionality of the mobile computing device without reliance on typical capacitive touchscreen controls.

As used herein, the term “hardware actuator” may refer to any physical button, contact, lever, or other user-interactive control that does not rely on a capacitive, inductive, or electrically resistive quality of the user. Also as used herein, the term “mobile computing device” may refer to any suitable type of computing device, and includes such non-limiting examples as a mobile phone, a smart phone, a tablet, and a personal digital assistant. Similarly, as used herein the term “mobile application” may refer to any set of instructions executable by one or more processors of a mobile computing device.

In particular, in certain embodiments an executing mobile application may assign a first function of the mobile application and/or mobile computing device (such as a mode selection function) to a first hardware actuator of the mobile computing device, and assign a set of additional functions of the mobile application and/or mobile computing device to other hardware actuators.

As one example, the mobile application may assign a ‘mode selection’ function to a first hardware actuator of the mobile computing device. Thus, as a particular mode is selected (out of multiple such available modes) using the first hardware actuator, particular functions associated with the selected mode may be assigned to one or more additional hardware actuators of the mobile computing device. In this manner, a user of the mobile computing device may cycle between modes using the first hardware actuator, and access various functions associated with each selected mode using the additional hardware actuators. As one example, the user of a mobile camera application may be able to cycle between video capture, still-image capture, audio capture, and other operating modes using a “volumedown” button of the mobile computing device, with the “volumeup” button of the mobile computing device being assigned a different function of the mobile camera application in each of those operating modes.

As another example, the mobile application may assign a ‘feature selection’ function to a first hardware actuator of the mobile computing device, and assign a ‘feature activation’ function to a second hardware actuator of the mobile computing device. In this manner, the mobile computing device may be configured by the mobile application so that the first hardware actuator (such as a “volumedown” button) cycles through various features, and the second hardware actuator (such as a “volumeup” button) activates the feature. Although the hardware actuators of the mobile computing device are exemplified herein as volume buttons, it should be understood that any function of the mobile application and/or mobile computing device may be assigned by the mobile application to any suitable hardware actuator of the mobile computing device.

In certain embodiments, the techniques described herein may be utilized in conjunction with an external device case operable to enclose a mobile computing device for protected use in wet, underwater, or other atypical environments. One non-exclusive example of such an external device case is described in U.S. Patent Application No. 62/153,002, which is hereby incorporated by reference in its entirety. The exemplary device case may comprise a top portion and a bottom portion, such that at least one of the top portion and the bottom portion includes a gasket configured to sealingly contact the top portion and the bottom portion. The exemplary device case may further include one or more buttons, each of which may be configured to sealingly extend into the top portion and/or the bottom portion, and may additionally include a clasp configured to reversibly hold the top portion and the bottom portion in a closed configuration.

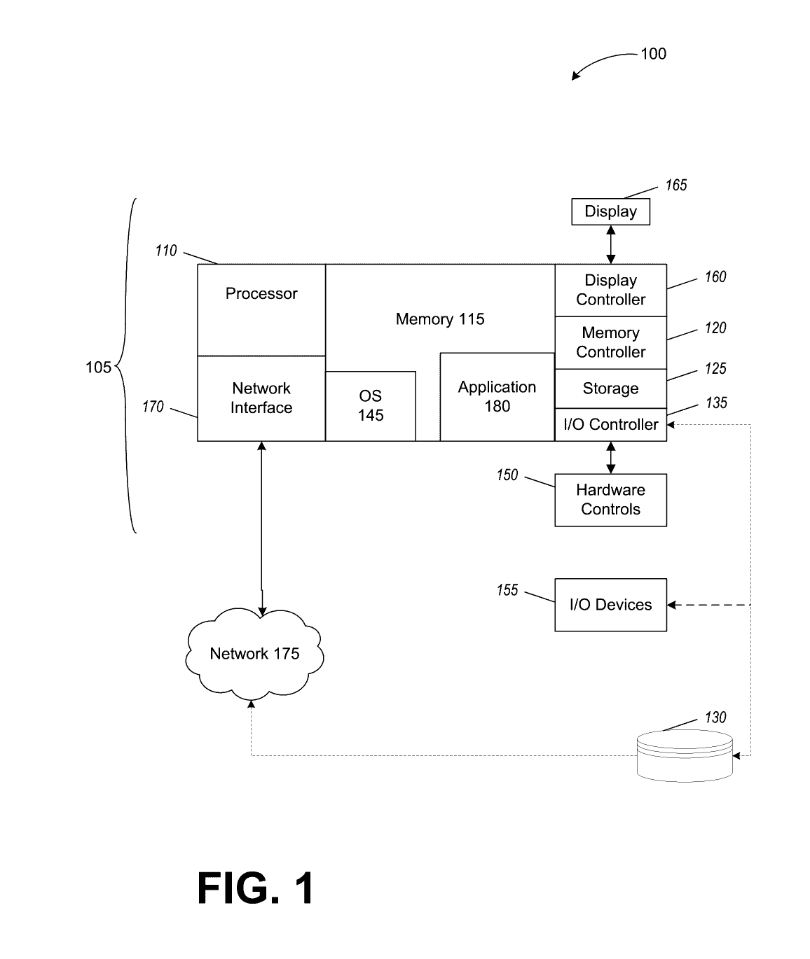

With reference now to FIG. 1, a block diagram of a computing system 100 for use in practicing the techniques described herein is depicted. Such techniques may be performed or otherwise implemented via hardware, software (e.g., firmware), or combination thereof. In an exemplary embodiment, the methods described herein are implemented in hardware, and may be part of the microprocessor of a special or general-purpose digital computer, such as a mobile computing device. The illustrative computing system 100 therefore includes mobile computing device 105.

In the illustrated embodiment of FIG. 1, the mobile computing device 105 includes a processor 110, a memory 115 coupled to a memory controller 120, internal storage 125, and one or more hardware actuator controls 150 that may be, for example, positioned on one or more surfaces of the mobile computing device and communicatively coupled to a local input/output controller 135. The input/output controller 135 may include one or more buses or other wired or wireless connections, as is known in the art. The input/output controller 135 may further include additional elements, which are omitted for simplicity, such as controllers, buffers (caches), drivers, repeaters, and receivers, to facilitate communications. Further, the local interface may include address, control, and/or data connections to facilitate appropriate communications among the aforementioned components. In the depicted embodiment, the computing system 100 further includes a display controller 160 coupled to a display 165 (such as but not limited to a touchscreen display), and a network interface 170 communicatively coupled to a network 175. In the illustrated embodiment, the computing system 100 is communicatively coupled to external storage 130 via one or both of the local input/output controller 135 and the network interface 170.

Also in the illustrated embodiment, the processor 110 is a hardware device for executing hardware instructions or software, particularly that stored in memory 115. The processor 110 can be any custom made or commercially available processor, a central processing unit (CPU), an auxiliary processor among several processors associated with the general-purpose mobile computing device 105, a semiconductor based microprocessor (in the form of a microchip or chip set), a macroprocessor, or generally any device for executing instructions.

The memory 115 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 115 may incorporate electronic, magnetic, optical, and/or other types of storage media. Note that the memory 115 can have a distributed architecture, where various components are situated remote from one another, but can be accessed by the processor 110.

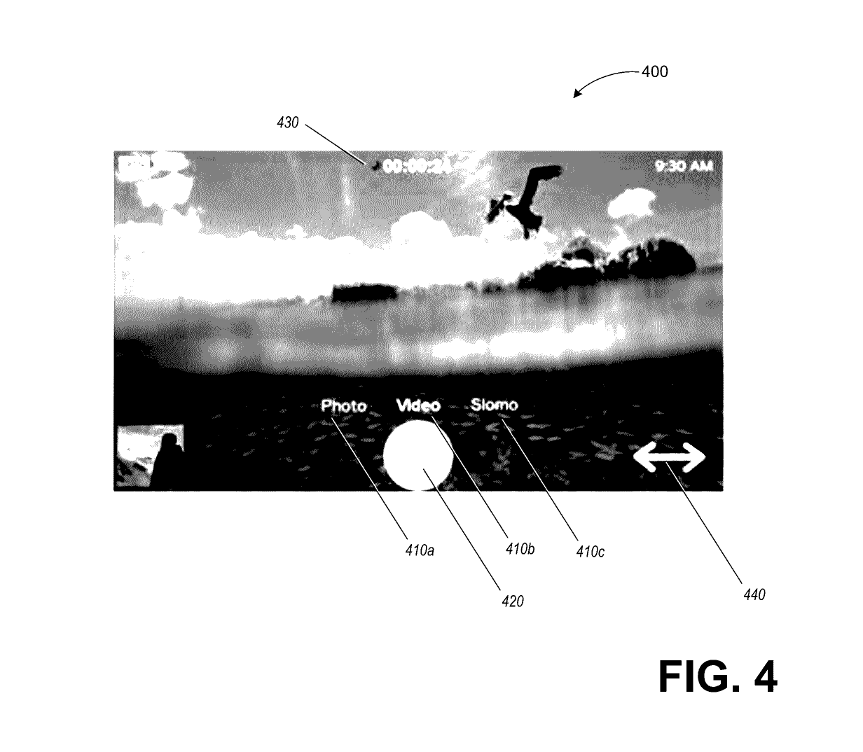

The instructions in the memory 115 may include one or more separate programs, each of which comprises an ordered listing of executable instructions for implementing logical functions. In the example of FIG. 1, the instructions in the memory 115 include a suitable operating system (OS) 145. The operating system 145 typically controls the execution of other computer programs and may, among other capabilities, provide scheduling, input-output control, file and data management, memory management, and communication control and related services. Applications executed by the mobile computing device may interact with input-output control modules of the OS (not shown) in order to perform various I/O tasks, including to assign particular functions to areas of a graphical user interface, hardware actuators of the mobile computing device, or both. In the depicted embodiment of FIG. 1, the instructions in memory 115 further include an executing mobile application 180, which is described in greater detail with respect to FIG. 4 below.

In certain embodiments, I/O controller 135 may be further interfaced with various I/O devices 155 which may include, as non-limiting examples, a keyboard, mouse, printer, scanner, microphone, a network interface card (NIC) or modulator/demodulator (for accessing other files, devices, systems, or a network), a radio frequency (RF) or other transceiver, a telephonic interface, a bridge, a router, and other peripherals communicatively coupled to the mobile computing device 105 via input/output controller 135.

The network 175 may be an IP-based network for communication between mobile computing device 105 and any external server, client and the like via a broadband or other network connection. The network 175 transmits and receives data between the mobile computing device 105 and external systems. In an exemplary embodiment, the network 175 may be a managed IP network administered by a service provider. The network 175 may be implemented in a wireless fashion, e.g., using wireless protocols and technologies, such as WiFi, WiMax, etc. The network 175 may also be a packet-switched network such as a local area network, wide area network, metropolitan area network, Internet network, or other similar type of network environment. The network 175 may be a fixed wireless network, a wireless local area network (LAN), a wireless wide area network (WAN) a personal area network (PAN), a virtual private network (VPN), intranet or other suitable network system and includes equipment for receiving and transmitting signals.

In at least some embodiments, the memory 115 may further include a basic input output system (BIOS) (omitted for simplicity). The BIOS is a set of routines that initialize and test hardware at startup, initiate execution of the OS 145, and support the transfer of data among the hardware devices. The BIOS is typically stored in ROM so that the BIOS may be executed when the mobile computing device 105 is activated. When the mobile computing device 105 is in operation, the processor 110 is configured to execute instructions stored within the memory 115, to communicate data to and from the memory 115, and to generally control operations of the mobile computing device 105 pursuant to the instructions.

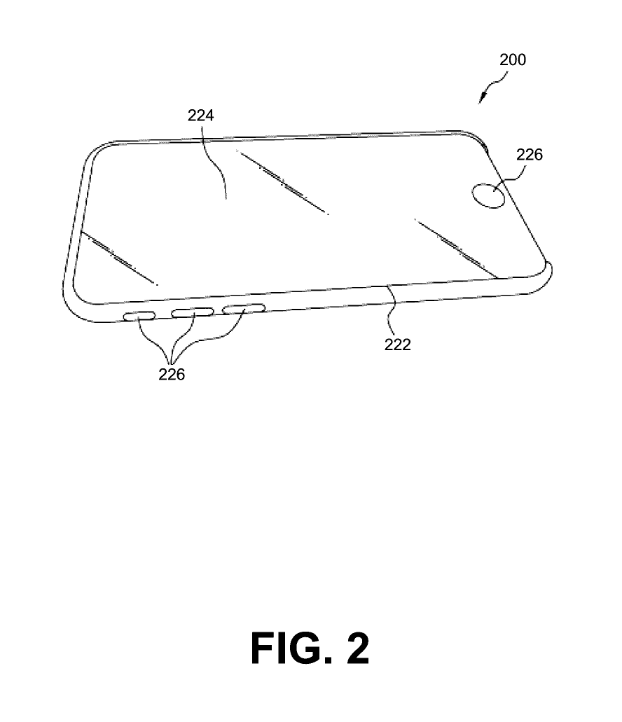

With reference now to FIG. 2, an example of a mobile computing device 200 is illustrated. The mobile computing device 200 includes a body 222 and at least one screen 224 for displaying information to a user. The screen 224 may, but need not be a touchscreen, which is responsive to the application of pressure thereto by a user. The mobile computing device 200 may additionally include one or more hardware actuators 226 (such as buttons or contacts), disposed on any of a plurality of surfaces of the device 200. The hardware actuators 226 may, for example, include a power button, ‘volume up’ and ‘volume down’ buttons, and ‘home’ button, and may be operable to scroll or make selections related to settings or operation of the mobile computing device 200. In the illustrated, non-limiting embodiment, the device includes a camera (not shown) such that the mobile computing device 200 is operable to take at least one of a photograph and a video. The mobile computing device 200 illustrated and described herein is intended only as an example.

FIG. 4 illustrates a graphical user interface (GUI) 400 displaying a plurality of visual controls associated with the executing mobile application (such as may be displayed by mobile computing device 105 of FIG. 1 or mobile computing device 200 of FIG. 2). In the depicted embodiment, the GUI 400 is provided as part of an executing mobile camera application, and displays visual indications of various functions that have been assigned to hardware actuators of the mobile computing device via interactions of the mobile application with I/O control modules of the operating system. In particular, mode indicators 410a, 410b, and 410c indicate three modes of operation that may be switched between using a first hardware actuator of the mobile computing device (e.g., a “volumedown” button) as indicated by mode switch indicator 440. As depicted, the currently selected mode in which the mobile application is operating is “Video,” indicated by its position directly above activation control 420, as well as its current display of a bolded font style (as opposed to the regular font style of alternative modes “Photo” and “Slomo”).

As non-limiting examples, additional operating modes for a mobile camera application may, in certain embodiments, include “4k” or other high-resolution modes; one or more photographic timer modes; one or more panoramic modes; one or more time-lapse modes; one or more high dynamic range (HDR) modes; one or more settings modes (e.g., for altering settings such as frames per second, photographic exposure, photographic resolution or quality, or other suitable settings of the mobile application and/or mobile computing device); etc. In various embodiments, various visual indicia may be used in addition to or in lieu of those shown in the illustrated embodiment of FIG. 4, and certain visual indicia may be omitted entirely.

Activation control 420 corresponds in the depicted embodiment to a second hardware actuator of the mobile computing device (e.g., a “volumeup” button). In at least some embodiments, the function of the mobile computing device that is assigned the second hardware actuator may vary according to the particular mode that is currently selected. Furthermore, functions assigned to particular hardware actuators in one mode may be assigned to different hardware actuators of the mobile computing device in another mode, or may be unavailable in another mode. For example, with respect to FIG. 4, recording indicator 430 indicates in the current “Video” mode that the mobile computing device is currently recording video, and has been doing so for 24 seconds—however, such video recording may be unavailable when the mobile computing device is operating in the “Photo” mode of the executing mobile application.

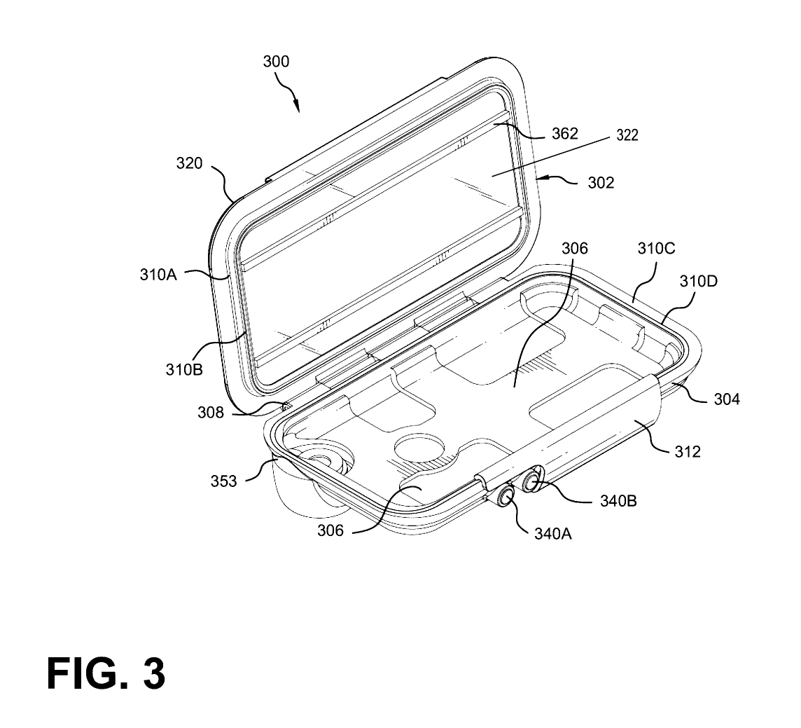

With reference now to FIG. 3, an embodiment of an external device case 300 is illustrated, such as may be suitable for enclosing mobile computing device 105 of FIG. 1 and/or mobile computing device 200 of FIG. 2. The mobile computing device may comprise one or more of a sensor, a touch-sensitive screen, and other electronic components that may be sensitive to damage from their environment, such as from liquids such as water coming in contact with the mobile device. The device case 300 allows use of the mobile computing device in a wet or otherwise device-incompatible environment without damage to the mobile computing device. In an embodiment, the mobile computing device may be placed inside a cavity 306 of the device case 300, and the device case 300 closed around the device 20 to form a water-tight seal, thereby allowing for use of the device 20 in a wet environment without damage. This is beneficial because the case 300 protects the mobile computing device from everyday spills and mishaps, and further allows for use of the mobile computing device (such as to take photographs or videos) while underwater.

The device case 300 includes a complementary top portion 302 and bottom portion 304 which are configured to cooperate with one another to contain a mobile computing device within the cavity 306 defined between the top and bottom portions 302 and 304. In an embodiment, the cavity 306 has a shape and size substantially similar to that of the mobile computing device intended to be enclosed therein.

The top portion 302 and the bottom portion 304 are movable relative to one another, for example between an open configuration and a closed configuration (not shown) to allow a user to easily access the cavity 306 to install a mobile computing device therein or remove a mobile computing device therefrom. In the closed configuration, the top portion 302 and the bottom portion 304 are arranged in a substantially overlapping configuration. A hinge 308 may be used to rotatably connect the top portion 302 and the bottom portion 304. In the illustrated, non-limiting embodiment of FIG. 3, the hinge 308 is arranged adjacent a side of the device case 300 to hingably connect the top portion 301 and the bottom portion 302 to facilitate opening of the device case 300 in a manner similar to a clam shell. The hinge 308 illustrated and described herein is intended as an example only. It should be understood that other types of mechanisms may be used to movably couple the top and bottom portions 302 and 304 of the device case 300. Further, embodiments where the top portion 302 is wholly separable from the bottom portion 304 are also considered within the scope of the disclosure. In the depicted embodiment of FIG. 3, the external device case 300 additionally includes a camera lens assembly 353, which may be aligned to enable photographic and/or video capture using a camera of an enclosed mobile computing device.

In the depicted embodiment, at least one of the top portion 302 and the bottom portion 304 includes a gasket 310. The gasket 310 may be positioned on a surface of one or both of the top and bottom portions 302 and 304 and adjacent the cavity 306, and is configured to provide a watertight seal between the top portion 302 and the bottom portion 304 when the case is in the closed configuration. In an embodiment, both the top portion 302 and the bottom portion 304 each independently comprise a gasket, such as a primary gasket and a secondary gasket for example, to provide additional protection from the ingress of water. As shown in FIG. 3, the top portion 302 may comprise a first gasket 310A and a second gasket 310B, and the bottom portion 304 may comprise a third gasket 310C and a fourth gasket 310D. However, any of the first gasket 310A, second gasket 310B, third gasket 310C and fourth gasket 310D may be omitted if desired. A device case 300 having any suitable number of gaskets 310 is considered within the scope of the disclosure.

In the depicted embodiment, a clasp 312 is movable between a first open position and a second closed position, and may be configured to selectively retain the top portion 302 and the bottom portion 304 in a closed configuration. Each clasp 312 may be independently connected to one of the top portion 302 and the bottom portion 304, and may be configured to rotate and engage the other of the top portion 302 and the bottom portion 304. Any suitable type of clasp 312 is considered within the scope of the disclosure. In certain embodiments, the device case 300 may include a plurality of clasps 312, and may be arranged on the same side or on different sides of the case 300.

The top portion 302 of the device case 300 comprises a frame 320 and a window 322 disposed in the frame 320. In the depicted embodiment, the device case 300 further includes a shock absorbing member 362. The window 322 may be configured to provide a user with visual, and optionally, touch access to a display and/or touchscreen of a mobile computing device housed within the cavity. Thus, in at least one embodiment, window 322 may comprise a touch-screen compatible material, such as a touch sensitive glass for example, to allow for manipulation of and interaction with an adjacent touchscreen of a mobile computing device enclosed within the device case 300. Further, the top portion 302 and the bottom portion 304 of the device case 300 may each independently comprise a transparent or optically clear material to allow for viewing, and optionally actuating, multiple screens or indicators.

The device case 300 may further include one or more buttons 340 configured to sealingly extend (i.e., movably protrude) into a portion of the external device case 300 in order to activate a hardware actuator of a mobile computing device housed within the cavity 306 of the external device case. In the depicted embodiment, the external device case 300 includes a first button 340A and a second button 340B. In certain embodiments, the buttons may be configured to maintain the watertight seal of the cavity 306 when the device case 300 is in the closed configuration.

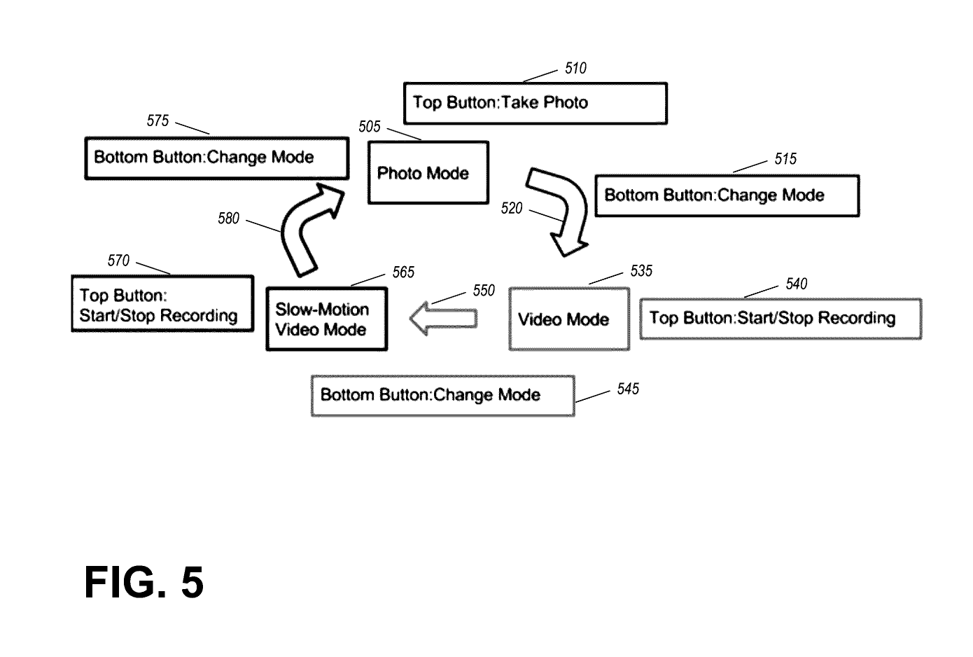

With reference now to FIG. 5, an exemplary state flow diagram of device function assignment is provided in accordance with one embodiment of techniques described herein. In particular, FIG. 5 depicts cyclical hardware actuator assignments for a mobile computing device, such as may be implemented via interactions of a mobile application executing on the mobile computing device with I/O control modules of the mobile computing device operating system. Such assignments may, for example, be implemented by the mobile application 180 of FIG. 1, and may be visually reflected in the graphical user interface presented in FIG. 4 described above.

FIG. 5 illustrates three distinct modes of operation for an executing mobile camera application: Photo Mode 505, Video Mode 535, and Slow-Motion Video Mode 565. Arbitrarily beginning in Photo Mode 505, button assignments associated with the three distinct modes of operation are also depicted. In particular, while operating in Photo Mode, a top button is assigned the “Take Photo” function via assignment 510, and a bottom button is assigned the “Change Mode” function via assignment 515. Upon activation of the bottom button while operating in Photo Mode, the “Change Mode” function is performed via mode transition 520, causing the mobile computing device to then operate in Video Mode 535. While operating in Video Mode, the top button is assigned the “Start/Stop Recording” function via assignment 540, while the bottom button is assigned (or, in certain embodiments, maintained as) the “Change Mode” function via assignment 545. Upon activation of the bottom button while operating in Video Mode, the “Change Mode” function is performed via mode transition 550, causing the mobile computing device to then operate in Slow-Motion Video Mode 565. While operating in Slow-Motion Video Mode, the top button is assigned the “Start/Stop Recording” function via assignment 570, while the bottom button is assigned (or, in certain embodiments, maintained as) the “Change Mode” function via assignment 575. Upon activation of the bottom button while operating in Slow-Motion Video Mode, the “Change Mode” function is performed via mode transition 580, causing the mobile computing device to then operate in Photo Mode 505 in the manner described above.

In certain embodiments, additional functionality may be provided via timed activation of one or more hardware actuators of the mobile computing device. In this manner, particular modes or features may be activated or deactivated by continuously depressing a hardware actuator of the mobile computing device (or corresponding button of an external device case enclosing the mobile computing device) for a predefined duration. For example, a particular mode or feature may be activated or deactivated when a single hardware actuator is depressed for two seconds, while another mode or feature may be activated or deactivated when two or more hardware actuators (or corresponding external device case buttons) are simultaneously depressed for two seconds, five seconds, or other defined period of time. In at least some embodiments, the mobile application may enable a user to specify one or more configuration parameters for function assignments, including such time-specific activation as well as for single untimed activations of a particular hardware actuator.

In this disclosure some but not all embodiments of this disclosure are described. This disclosure may be embodied in many different forms and is not be construed as limited to the embodiments set forth herein; rather, these embodiments are provided so that this disclosure will fully convey the scope of the invention to those skilled in the art.

It will be understood that when an element is referred to as being “on” another element, it can be directly on the other element or intervening elements may be present there between. In contrast, when an element is referred to as being “directly on” another element, there are no intervening elements present.

It will be understood that, although the terms “first,” “second,” “third,” etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer or section without departing from the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be appreciated that in some embodiments the functionality provided by the methodologies or routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, it will be appreciated that in other embodiments the operations may be performed in other orders and in other manners. It will also be appreciated that particular data structures discussed above may be structured in different manners, such as by having a single data structure split into multiple data structures or by having multiple data structures consolidated into a single data structure. Similarly, in some embodiments, illustrated data structures may store more or less information than is described, such as when other illustrated data structures instead lack or include such information respectively, or when the amount or types of information that is stored is altered.

The present invention may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Flowchart, state, and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method implemented by a processor-based computing device, the method comprising:
providing a user interface having a plurality of modes, each of the plurality of modes being associated with one or more device functions of the computing device such that at least one of the one or more device functions is unavailable for use during operation while the computing device is operating in at least one other of the plurality of modes, the providing of the user interface including:
assigning a mode selection function to a first hardware actuator of the computing device;
causing the computing device to operate in a first of the plurality of modes, wherein causing the computing device to operate in the first mode includes assigning a first set of the one or more device functions associated with the first mode to one or more second hardware actuators of the computing device; and
in response to a first activation of the first hardware actuator, causing the computing device to operate in a distinct second of the plurality of modes, wherein causing the computing device to operate in the distinct second mode includes assigning a distinct second set of the one or more device functions associated with the distinct second mode to the one or more second hardware actuators of the computing device.

2. The computing device-implemented method of claim 1 wherein the plurality of modes are logically arranged in a predefined order, and wherein causing the computing device to operate in the distinct second mode in response to activation of the first hardware actuator includes causing the computing device to shift operation from the first mode to a next mode in the predefined order that is the distinct second mode.

3. The computing device-implemented method of claim 2 wherein the first mode is an initial mode in the predefined order of the plurality of modes, wherein the predefined order of the plurality of modes comprises a cyclical series such that shifting operation from a last of the plurality of modes to a next mode in the predefined order includes causing the computing device to operate in the initial first mode.

4. The computing device-implemented method of claim 1, wherein the distinct second mode is a photographic mode, and wherein causing the computing device to operate in the distinct second mode includes assigning an image capture function associated with the distinct second mode to one of the second hardware actuators of the computing device.

5. The computing device-implemented method of claim 1, wherein the distinct second mode is a video recording mode, and wherein causing the computing device to operate in the distinct second mode includes assigning a video recording function associated with the distinct second mode to one of the second hardware actuators of the computing device.

6. The computing device-implemented method of claim 1 further comprising, in response to a second activation of the first hardware actuator that occurs after the first activation of the first hardware actuator, causing the computing device to operate in a distinct third of the plurality of modes, wherein causing the computing device to operate in the distinct third mode includes assigning a distinct third set of the one or more device functions associated with the distinct third mode to the one or more second hardware actuators of the computing device.

7. A non-transitory computer-readable medium having stored contents that, when executed, configure a computing device having a plurality of hardware actuators to:
assign a first function to a first of the hardware actuators;
in response to a first user activation of the first hardware actuator, assign a first set of additional device functions to one or more of the plurality of hardware actuators other than the first hardware actuator; and
in response to a distinct second user activation of the first hardware actuator that occurs after the first user activation of the first hardware actuator, assign a distinct second set of additional device functions to the one or more other hardware actuators.

8. The non-transitory computer-readable medium of claim 7 wherein the stored contents further configure the computing device to, upon user activation of the first hardware actuator after the assignment of the first function to the first hardware actuator, cause the computing device to operate in a next mode of a plurality of modes that are each associated with a distinct set of device functions, wherein the first set of additional device functions is associated with a first of the plurality of modes, and wherein the distinct second set of additional device functions is associated with a second of the plurality of modes.

9. The non-transitory computer-readable medium of claim 8 wherein the first function is a mode selection function, wherein the plurality of modes are logically arranged in a predefined order, and wherein the stored contents further configure the computing device to, in response to activation of the mode selection function, shift operation to a next mode in the predefined order.

10. The non-transitory computer-readable medium of claim 9 wherein the predefined order of the plurality of modes comprises a cyclical series such that shifting operation from a last mode of the predefined order to a next mode in the predefined order includes causing the computing device to operate in an initial mode of the predefined order.

11. The non-transitory computer-readable medium of claim 7, wherein the first set of additional device functions includes one or more of a group that includes a camera flash control function, an audio capture control function, a camera zoom control function, a positioning sensor control function, and a camera configuration control function.

12. The non-transitory computer-readable medium of claim 7, wherein the distinct second set of additional device functions includes a video recording function.

13. A system, comprising:
an external device case that includes one or more buttons, each of the one or more buttons being configured to sealingly extend when actuated in order to activate a corresponding hardware actuator of a computing device when the computing device is enclosed by the external device case; and
a non-transitory computer-readable medium having contents that, when executed by the computing device, cause the computing device to perform a method comprising:
providing a user interface having a plurality of modes, each of the plurality of modes being associated with one or more device functions of the computing device such that at least one of the one or more device functions is unavailable for use during operation of the user interface while operating in at least one other of the plurality of modes, the providing of the user interface including:
assigning a mode selection function to a first hardware actuator of the computing device;
causing the computing device to operate in a first of the plurality of modes, wherein causing the computing device to operate in the first mode includes assigning a first set of the one or more device functions associated with the first mode to one or more second hardware actuators of the computing device; and
in response to activation of the first hardware actuator, causing the computing device to operate in a distinct second of the plurality of modes, wherein causing the computing device to operate in the distinct second mode includes assigning a distinct second set of the one or more device functions associated with the distinct second mode to the one or more second hardware actuators of the computing device.

14. The system of claim 13, further comprising the computing device.

15. The system of claim 13, wherein the external device case further includes a top portion and a bottom portion and a gasket configured to sealingly contact the top portion and the bottom portion when the computing device is enclosed by the external device case.

16. The system of claim 15, wherein each of at least one of the one or more buttons is configured to movably protrude into the at least one of the top portion and the bottom portion in alignment with the corresponding hardware actuator of the computing device when the computing device is enclosed by the external device case.

17. The system of claim 13 wherein the plurality of modes are logically arranged in a predefined order, and wherein causing the computing device to operate in the distinct second mode in response to activation of the first hardware actuator includes causing the computing device to shift operation from the first mode to a next mode in the predefined order that is the distinct second mode.

18. The system of claim 17 wherein the first mode is an initial mode in the predefined order of the plurality of modes, wherein the predefined order of the plurality of modes comprises a cyclical series such that shifting operation from a last of the plurality of modes to a next mode in the predefined order includes causing the computing device to operate in the initial first mode.

19. The system of claim 13, wherein the distinct second mode is a photographic mode, and wherein causing the computing device to operate in the distinct second mode includes assigning an image capture function associated with the distinct second mode to one of the second hardware actuators of the computing device.

20. The system of claim 13, wherein the distinct second mode is a video recording mode, and wherein causing the computing device to operate in the distinct second mode includes assigning a video recording function associated with the distinct second mode to one of the second hardware actuators of the computing device.
